(19) United States
(12) Patent Application Publication
(10) Pub. No.: US 2013/0071944 A1
(43) Pub. Date: Mar. 21, 2013

(54) SAMPLE PREPARATION DISPOSABLE DEVICES AND SAMPLE COLLECTION AND PREPARATION METHODS USING SAME

(71) Applicants: M. Scott Ulrich, Columbus, OH (US); R. Reade Harpham, Columbus, OH (US); April L. Fiorelli, Columbus, OH (US)

(72) Inventors: M. Scott Ulrich, Columbus, OH (US); R. Reade Harpham, Columbus, OH (US); April L. Fiorelli, Columbus, OH (US)

(73) Assignee: BATTELLE MEMORIAL INSTITUTE, Columbus, OH (US)

(21) Appl. No.: 13/497,592

(22) PCT Filed: Oct. 4, 2010
(86) PCT No.: PCT/US10/51302

§ 371 Date: Nov. 14, 2012

Related U.S. Application Data
(60) Provisional application No. 61/248,586, filed on Oct. 5, 2009.

(51) Int. Cl. G01N 1/31

(52) U.S. Cl. CPC G01N 1/31
USPC 436/174; 422/554

(57) ABSTRACT

An article of manufacture embodiment comprises a sample cartridge including a sample substrate, and an enclosure including a sample ingress port. The enclosure mates with the sample cartridge to define a sample container containing the sample substrate which is accessible in the sample container via the sample ingress port. The sample cartridge including the sample substrate is removable from the sample container. A sampling method embodiment comprises disposing a sample on a sample substrate in a sample container and removing a sample cartridge including the sample substrate from the sample container. An article of manufacture embodiment comprises a sample substrate, a sample container containing the sample substrate and including a sample ingress port providing access to the sample substrate in the sample container, and a sample cartridge including the sample substrate. The sample cartridge including the sample substrate is removable as a unit from the sample container.

This application claims the benefit of U.S. Provisional Application No. 61/248,586 filed Oct. 5, 2009 titled “SAMPLE PREPARATION DISPOSABLE DEVICES AND SAMPLE COLLECTION AND PREPARATION METHODS USING SAME”. U.S. Provisional Application No. 61/248,586 filed Oct. 5, 2009 titled “SAMPLE PREPARATION DISPOSABLE DEVICES AND SAMPLE COLLECTION AND PREPARATION METHODS USING SAME” is incorporated herein by reference in its entirety.

### BACKGROUND

The following relates to the sample preparation arts, sample testing arts, microbiological testing arts, optical characterization arts, and so forth.

WO 2007/009119 A2 published Jan. 18, 2007 is incorporated herein by reference in its entirety. WO 2007/009119 A2 relates to systems and methods for biological and chemical detection and names Battelle Memorial Institute, Columbus, Ohio, USA as applicant.

Raman spectroscopy is known for use in microbiological testing. By way of illustrative example, some such techniques are disclosed in WO 2007/009119 A2, and a known microbiological testing system employing Raman spectroscopy is the Rapid Enumerated Bioidentification System (REBS) developed by Battelle Memorial Laboratories (Columbus, Ohio, USA).

For microbiological testing, a sample is typically disposed on a substrate sized to fit into the Raman testing apparatus. The substrate may, for example, be a disk. For testing techniques that require light transmission through the substrate, the substrate is made of a transparent material such as glass, and/or is made thin enough to be optically transparent or translucent. Diverse techniques are employed to collect and dispose the biological sample on the substrate, with the techniques used in a particular test being dependent on whether the biological material is airborne, waterborne, disposed in some other type of fluid (e.g., milk in the case of testing for dairy contamination), or disposed on a surface. In addition to collection, the sample preparation may entail staining the biological material with a staining fluid designed to enhance contrast or detection of the biological material in the optical test apparatus.

### BRIEF SUMMARY

In accordance with one disclosed aspect, an article of manufacture comprises: a sample cartridge including a sample substrate; and an enclosure including a sample ingress port, the enclosure mating with the sample cartridge to define a sample container containing the sample substrate which is accessible in the sample container via the sample ingress port, the sample cat ridge including the sample substrate being removable from the sample container.

In accordance with another disclosed aspect, an article of manufacture comprises: a sample substrate; a sample container containing the sample substrate and including a sample ingress port providing access to the sample substrate in the sample container; and a sample cartridge including the sample substrate, the sample cartridge including the sample substrate being removable as a unit from the sample container.

In accordance with another disclosed aspect, an article of manufacture comprises a sample container including a removable sample cartridge having a sample substrate.

In accordance with another disclosed aspect, a sampling method comprises: disposing a sample on a sample substrate in a sample container; and removing a sample cartridge including the sample substrate from the sample container.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 shows a perspective view of a disposable device for collecting a preparing a sample for optical testing. FIG. 1 also shows a cartridge for insertion into the disposable device for delivering a controlled amount of a staining fluid.

FIG. 2 shows a perspective view of three disposable devices of the type shown in FIG. 1, with different cap designs configured for collecting samples from a gas, liquid, or surface, respectively.

FIG. 3 diagrammatically shows six stages in a sample collection and preparation process.

FIGS. 4-9 show perspective views of each of the six sample collection and preparation stages of FIG. 3, respectively.

### DETAILED DESCRIPTION OF PREFERRED EMBODIMENTS

A single use disposable device or sample container is provided for the purpose of preparing collected specimen samples for processing in a Rapid Enumerated Bioidentification System (REBS) analysis instrument (available from Battelle Memorial Laboratories, Columbus, Ohio, USA), or in another testing apparatus. The disposable device or sample container includes elements that cooperate to transform the specimen sample into a form that is accepted by (that is, configured to be loaded into) the REBS instrument or another designated testing apparatus. The disposable device or sample container includes various combinations of the following elements: a configurable sample collection reservoir, an interface that accepts a proprietary staining fluid vessel or package containing staining fluid, a removable cartridge containing an REBS filter medium or other suitable sample substrate, an interface and internal structure, such as a sample ingress port and/or integral swab for acquiring surface samples, that allows the specimen sample to be transferred onto the REBS filter media or other sample substrate, an optional on-board reservoir for collecting the vacuumed sample liquid, and a barcode label. These components are contained within and/or incorporated into an enclosure that facilitates handling. The disposable device or sample container will accept a single sample specimen.

Some functional aspects of the disposable device or sample container include: (i) the ability to accept a specimen sample from a liquid, air or surface source; (ii) an interchangeable cap design that facilitates configuring the disposable device for use with liquid/air or surface specimen samples; (iii) the ability to interface with a vacuum manifold; (iv) the ability to transfer the sample specimen from a liquid state onto REBS filter media or another suitable sample substrate by use of connection to vacuum pressure; (v) the ability to deliver a staining fluid, either through manual or automated means, onto the REBS filter media or other sample substrate; (vi) a manually removable cartridge containing or including REBS filter media or other sample substrate that is inserted into the REBS instrument for analysis; (vii) a barcode label, radio frequency identification (RFID) element, or other identification element included with the manually removable cartridge; and (viii) provide a closed loop sample preparation process that prevents sample contamination during the sample preparation and analysis processes.

The disposable device or sample container facilitates a preparation process that employs a staining fluid. Toward this end, individual single use blister packs or other staining fluid packages are provided containing liquid stain fluids for use in conjunction with the disposable device or sample container. A single-use blister pack or other staining fluid package is inserted into a mating receptacle of the disposable device or sample container, and the inserted blister pack or other staining fluid package is ruptured by a stain release member configured to rupture the staining fluid package to release the staining fluid into the sample container. The stain release member can be activated manually, for example using an external push-button disposed on the sample container, or can be activated automatically as the blister pack or other staining fluid package is inserted into the receptacle of the disposable device or sample container. For example, the stain release member can be a pin or other protrusion positioned such that insertion of the blister pack into the receptacle causes the stain release member to press against and ultimately rupture the blister pack at the point at which the blister pack is about fully inserted into the receptacle.

With reference to the FIGURES, some illustrative embodiments of articles of manufacture and sampling methods are set forth as further illustrative examples.

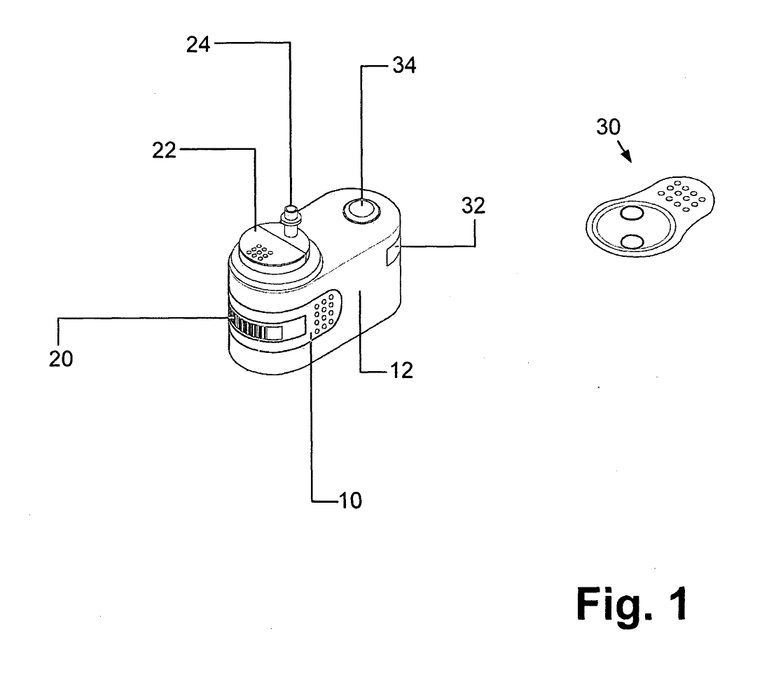

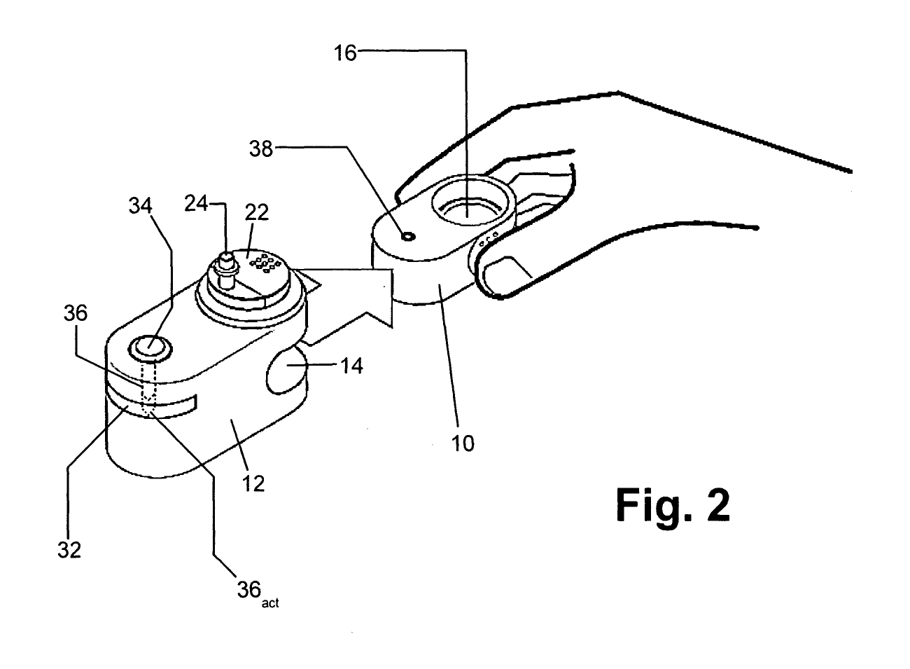

FIGS. 1 and 2 illustrate a suitable single use disposable device or sample container. A detachable sample cartridge 10 connects with a sealed disposable enclosure 12 to define the sample container. In the illustrated embodiment, the sample cartridge 10 slides into (for connection) or out of (for removal) a slot 14 in the enclosure 12. FIG. 1 shows the assembled article of manufacture in which the sample cartridge 10 is inserted into the enclosure 12 to form the sample container. FIG. 2 shows the sample cartridge 10 removed from the sample container so as to reveal the REBS media disk 16 or, more generally, the sample substrate 16. In a typical application, a sample is gathered in the field using the assembled sample container as shown in FIG. 1, and is transported in this assembled configuration to a testing laboratory. At the testing laboratory, a laboratory worker removes the sample cartridge 10 from the sample container (FIG. 2). In some embodiments, the sample cartridge 10 is configured for loading into a testing apparatus such as the REBS system (e.g., see FIG. 10). The disclosed sample container automates sample preparation operations such as disposing a particulate sample on a suitable sample substrate and optionally applying a stain fluid, provides for closed-loop sample preparation, and after collection the sample is advantageously protected from contamination and handling.

The illustrated sample cartridge 10 includes a barcode label 20 for establishing a chain of custody. More generally, it is advantageous for the sample cartridge 10 to include an identification element 20 such as the illustrated barcode label, or a human-readable label showing an identification number or alphanumeric sequence, or a radio frequency identification (RFID) element, or so forth. In the case of using a label as the identification element 20, the label can a sticker affixed by adhesive onto the sample cartridge, or can be in the form of an embossed label, stamped label, or so forth. Although including such an identification element is advantageous, it is also contemplated to omit the identification label.

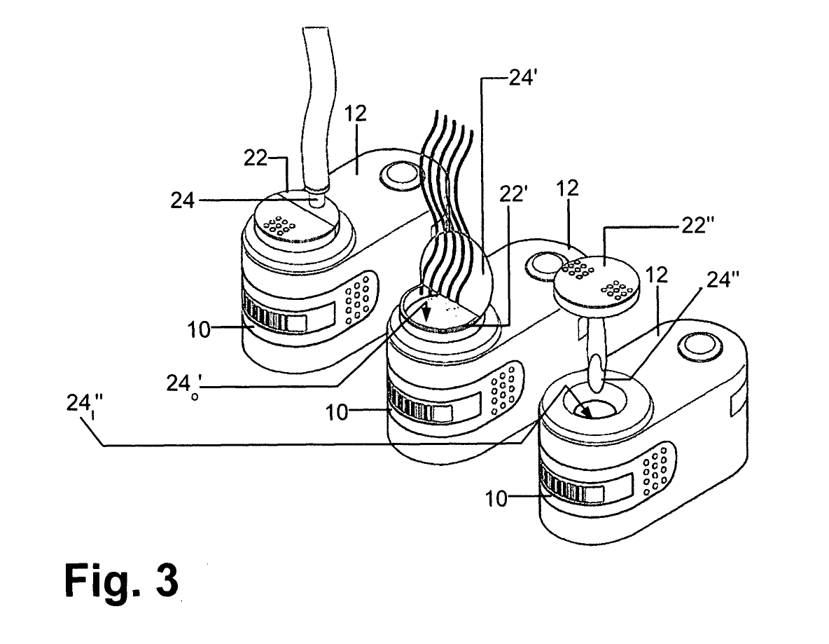

The sample container of FIG. 1 has a cap 22 including a connection port 24 for direct connection with a fluid source. Thus, a fluid sample can be input into the sample container via the connection port 24. With reference to FIG. 3, more generally the sample container includes a sample ingress port which can be variously configured based on the type of interchangeable cap that is disposed over the sample ingress port. As in the example of FIG. 1, one type of interchangeable cap 22 includes the connection port 24 for direct connection of a fluid input conduit. In another example shown in FIG. 3, another type of interchangeable cap 22′ includes a flip-top opening 24₀′ that is sealable by a flip-top 24′ and is suitable for sampling airborne substances (for example, by opening the flip-top 24′ and leaving it open for a while in an area suspected of containing airborne particulates of interest), waterborne (or, more generally, liquid-borne) substances by pouring a sample of the fluid into the sample container via the flip-top opening 24₀′. In another example shown in FIG. 3, another type of interchangeable cap 22″ includes a swab 24″ that is immersed in a liquid disposed in the sample container when the cap is disposed over the sample ingress port 24₁″. In this approach, the sample container comes pre-loaded with a sterile liquid such as deionized water, a selected solvent, or so forth. The cap 22″ including the attached swab 24″ is removed and the swab 24″ is used to collect (i.e., “swab”) a sample from a surface of interest, and the cap 22″ including the attached swab 24″ is replaced over the sample ingress port 24₁″—in so doing, the swab 24″ is immersed in the sterile liquid into which particulates of the swabbed surface sample disperse (or into which a substance of the swabbed surface sample dissolves, in the case of some types of chemical samples). FIG. 3 shows some illustrative cap configurations 22, 22′, 22″, and other configurations are also contemplated to facilitate collection of other types of samples from other environments. Advantageously, the sample container is not modified for these various collection approaches (except for providing a sterile liquid in conjunction with the surface-sampling cap configuration 22″). Rather, only the cap is interchanged.

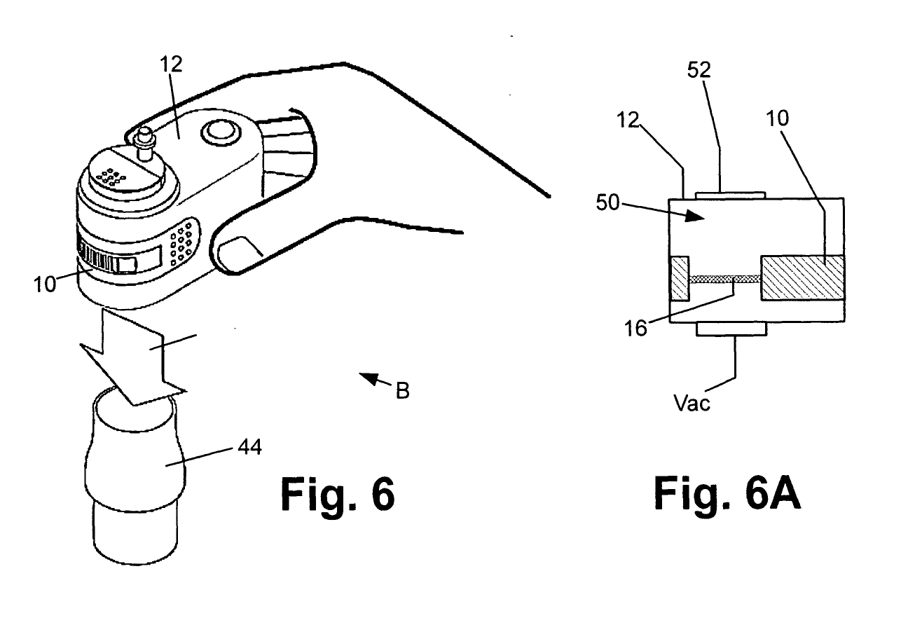

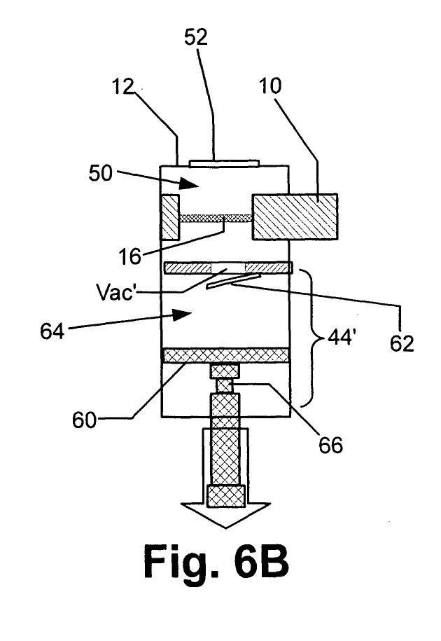

With returning reference to FIGS. 1 and 2, the sample container optionally includes a vacuum port (not visible in FIGS. 1 and 2, but see FIGS. 6A and 6B for two diagrammatic illustrative examples of vacuum ports Vac, Vac′). It will be noticed that when employing any of the airborne, liquid-borne, or surface-borne sample collection approaches of FIG. 3, the result is a fluid (gas or liquid) containing the sample. In the case of a particulate sample of interest (for example, a sample of suspected microbial contamination, or another type of biological sample comprising biological cells, or a sample of suspected mineral particulates, or so forth) a typical preparation operation is to isolate the particulates from the fluid. Conventionally, this is typically done by taking the sample out of its sample container and passing it through a suitable filtering medium, possibly under the motive force of a forced airflow or vacuum draw—however, this approach has disadvantages such as the possibility of sample contamination, exposure of human laboratory workers to the sample, loss of the sample during transfer to the filtering medium, requirement for a skilled laboratory worker to perform the particulate/fluid separation operation, and so forth. The sample container of FIGS. 1 and 2 addresses this problem by providing a vacuum port Vac, Vac′ as a component of the sample container, and also providing a suitable sample substrate 16 (such as an REBS media disk or a filtering substrate medium). A vacuum applied at the vacuum port draws the fluid past or through the sample substrate 16, so that particulates are left on the sample substrate while the fluid is removed via the vacuum port Vac, Vac′.

Another common sample preparation operation is staining, in which the sample is exposed to a staining fluid that provides or enhances contrast or detectability of particles of interest in the testing apparatus. In the illustrative case of REBS, suitable staining fluid can enable distinguishing different types of biological cells in the sample by analysis of spatially resolved Raman spectroscopy signals. See WO 2007/009119 A2 published Jan. 18, 2007 is incorporated herein by reference in its entirety. Conventionally, this is typically done by measuring out a precise dosage of the staining fluid and applying same to the sample substrate containing the sample. As with the particulate/fluid separation operation, this type of staining operation has disadvantages such as the possibility of contamination and/or laboratory worker exposure, the need for a skilled laboratory worker to perform the staining, the possibility of using too much or too little staining fluid, and/or the wrong type of staining fluid, and hence producing erroneous test results, or so forth. The sample container of FIGS. 1 and 2 addresses this problem by providing a staining fluid package 30 such as an illustrated stain blister pack 30 which is prefilled with the appropriate amount and type of staining fluid. The staining fluid package is inserted into a mating receptacle 32 of the enclosure 12 of the sample container, and a manual operation such as pressing an illustrated push button 34 causes a pin or other stain release member 36 (shown in phantom in FIG. 2; a dotted representation 36_{act} shows the release member position when activated) to rupture the staining fluid package 30 (e.g., punch a hole in the blister pack 30) so as to release the staining fluid.

In the illustrative embodiment, the sample cartridge 10 includes an optional stain fluid conduit 38 for passing the staining fluid directly to the sample substrate. The staining is suitably performed after the particulate/fluid separation operation. In other embodiments, the sample container may be shaken to facilitate dispersal of the staining fluid over the sample substrate. Optionally, the vacuum port Vac, Vac′ may again be applied, this time to remove excess staining fluid from the sample container.

In some other contemplated embodiments, the staining operation is performed before the particulate/fluid separation operation, in which case the fluid (e.g., water in which the particulates are suspended) provides a suitable medium for dispersing the staining fluid to the particulates. In such embodiments, the staining operation is performed prior to the particulate/fluid separation operation, and the staining operation optionally includes manual shaking of the sample container to facilitate complete dispersal of the staining fluid.

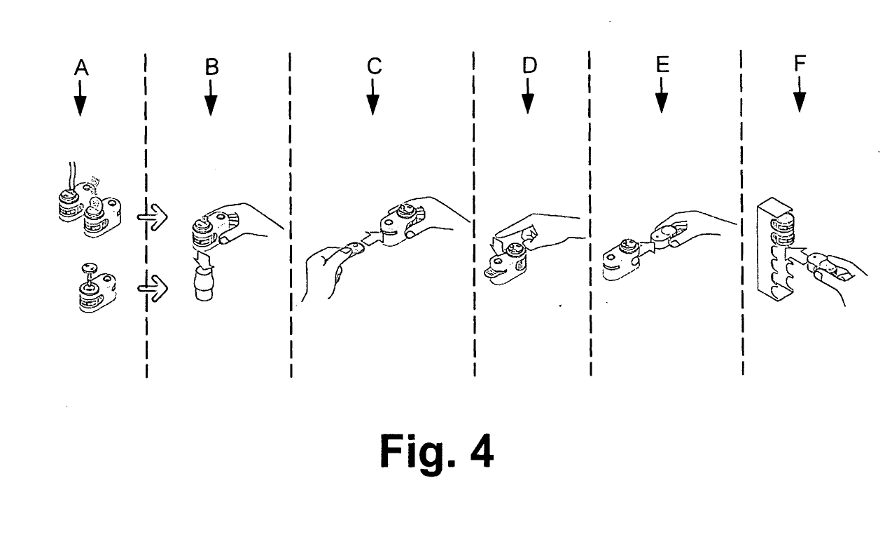

Having provided an overview of the illustrative sample container and some of its constituent features, a sample collection and preparation process is next described with reference to FIG. 4 and forward.

FIG. 4 provides an overview of the sample collection and preparation process, which is illustrated as six operations: a sample collection operation A; a fluid vacuuming (i.e., particulate/fluid separation) operation B; a staining fluid package insertion operation C; a sample staining operation D; a sample cartridge removal operation E; and a sample cartridge loading operation F in which the sample cartridge is loaded into the testing apparatus (or, in the illustrated example, into a multi-sample cartridge tray that is in turn loaded into the REBS testing apparatus). Subsequent FIGURES illustrate each operation A, B, C, D, E, F in turn.

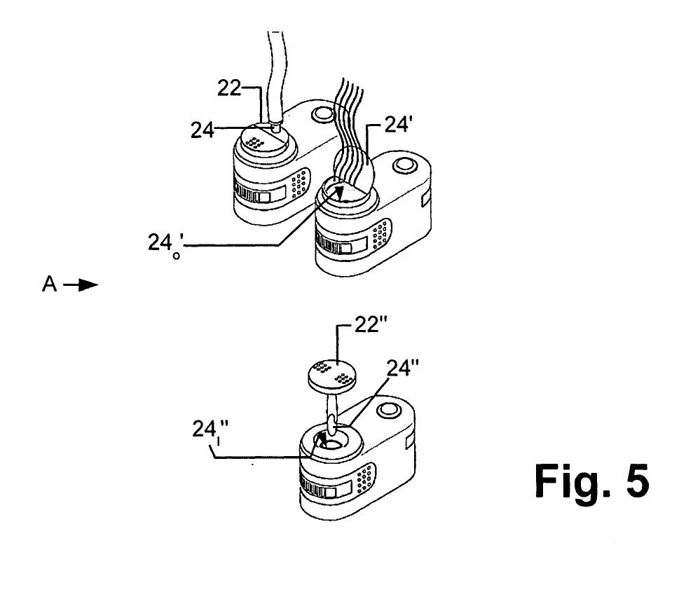

With reference to FIG. 5, the sample collection operation A is illustrated. This operation has already been described in some detail with reference to FIG. 3. The sample collection approach is dependent upon the type of sample (e.g., airborne, liquid-borne, or surface-borne), and the cap 22, 22′, 22″ covering the sample ingress port is selected to facilitate the type of collection to be performed, as already described with reference to FIG. 3. The illustrative cap 22 including the connection port 24 is suitable for fluid (e.g. liquid or gas) collection. The illustrative cap 22′ including the flip-top 24′ over the flip-top opening 24₀′ is suitable for fluid or airborne collection. The illustrative cap 22″ including the swab 24″ insertable into the sample ingress port 24₁″ is suitable for surface collection. To reduce likelihood of sample contamination, it is advantageous if the cap 22, 22′, 22″ is configured to seal the sample ingress port once the sample collection operation A is complete. Toward this end, all of the interchangeable caps 22, 22′, 22″ preferably secure over the sample ingress port in a sealed fashion, such as by threads disposed on the cap mating with threads of a threaded opening, or by having the caps snap over an annular lip of the sample ingress port, or so forth (sealing aspects not illustrated). Further toward this end, the flip-top 24′ is preferably resealable, and the connection port 24 is optionally a self-sealing fitting.

The particulate/fluid separation operation B is described with reference to FIGS. 6, 6A, and 6B. In the embodiment of FIGS. 6 and 6A, a vacuum nozzle 44 is connected with the vacuum port Vac so as to draw fluid from the sample container as indicated diagrammatically in FIG. 6. The detailed configuration of the sample container for performing the vacuum-mediated particulate/fluid separation operation B can vary. Two illustrative examples are shown in FIGS. 6A and 6B.

FIG. 6A shows an example in which the fluid is drawn into the vacuum nozzle 44. In this approach, the fluid is removed entirely from the sample container during the particulate/fluid separation operation B. The fluid-borne sample is loaded into a sampled fluid reservoir 50 via the sample ingress port 52 (which is to be understood may be capped by any of the illustrative caps 22, 22′, 22″). The sample cartridge 10 including the sample substrate 16 is disposed so as to separate the sampled fluid reservoir 50 from the vacuum port Vac. Application of a vacuum at the vacuum port Vac (for example, using the vacuum nozzle 44 as shown in FIG. 6) draws the fluid through the sample substrate 16 and thence through the vacuum port Vac to exit the sample container. The sample substrate 16 is made of a filtering material that retains particulates while passing the fluid. In some embodiments, the sample substrate 16 is an REBS media disk. The filtering properties of the sample substrate 16 are selected so as to retain particulates of a size of interest while passing smaller particulates and the fluid.

In a variant embodiment (not illustrated), the sample substrate is not porous or otherwise filtering, but rather is disposed in the path between the sampled fluid reservoir and the vacuum port, with peripheral gaps at the edges of the sample substrate. In this variant configuration, the fluid is not drawn through the sample substrate but rather flows laterally over the surface of the sample substrate as it flows toward the peripheral gaps and thence into the vacuum port Vac to exit the sample container. This variant embodiment relies upon adhesion of particles of interest to the surface of the sample substrate due to physical attraction, chemical attraction, physiochemical attraction, Van der Waals bonding, electrostatic bonding, magnetic bonding, or some other adhesive force. Toward this end, the sample substrate (or at least its surface) has chemical, electrostatic, magnetic, or other properties that promote the desired mechanism of particulate adhesion.

With reference to FIG. 6B, in another variant embodiment the vacuum port is defined by a built-in vacuum pump 44′ including a manually drawn piston 60 and a check valve 62 covering the vacuum port Vac′. The piston 60 is disposed in an on-board reservoir 64 for collecting vacuumed fluid. This on-board reservoir 64 also defines the piston cylinder for the piston 60. In this embodiment, during sample collection the piston 60 is positioned proximate to the check valve 62 so that the on-board reservoir 64 is isolated from the sampled fluid reservoir 50 and the sample substrate 16 by the piston 60. After the sample is collected, the piston 60 is withdrawn so as to create a vacuum in the on-board reservoir 64. The check valve 62 is oriented to allow fluid flow from the sampled fluid reservoir 50 to the on-board reservoir 64 for collecting vacuumed fluid, but to prevent the reverse fluid flow. Accordingly, withdrawing the piston 60 causes the fluid to flow from the sampled fluid reservoir 50 into the on-board reservoir 64 for collecting vacuumed fluid, where the fluid remains due to the flow-directional control provided by the check valve 62. During withdrawal of the piston 60, the fluid flows through or across the sample substrate 16 as already described with reference to FIG. 6A. When the piston withdrawal is complete, a narrowed break point 66 of the piston handle is exposed outside the sample container. The handle can be broken off at the break point 66 to facilitate subsequent handling.

FIGS. 6A and 6B are merely illustrative examples, and other vacuum-based particulate/fluid separation approaches are also contemplated. In still other variant embodiments (not illustrated) forced nitrogen or another forced sterile gas is used to “push” the fluid through or across the sample substrate to achieve the particulate/fluid separation, rather than using a vacuum to draw or “pull” the fluid.

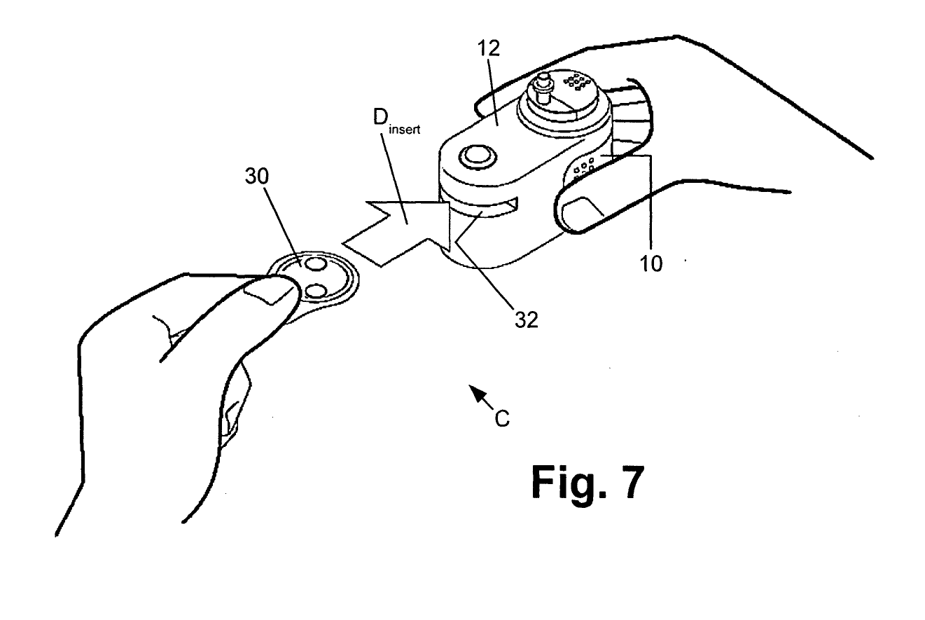

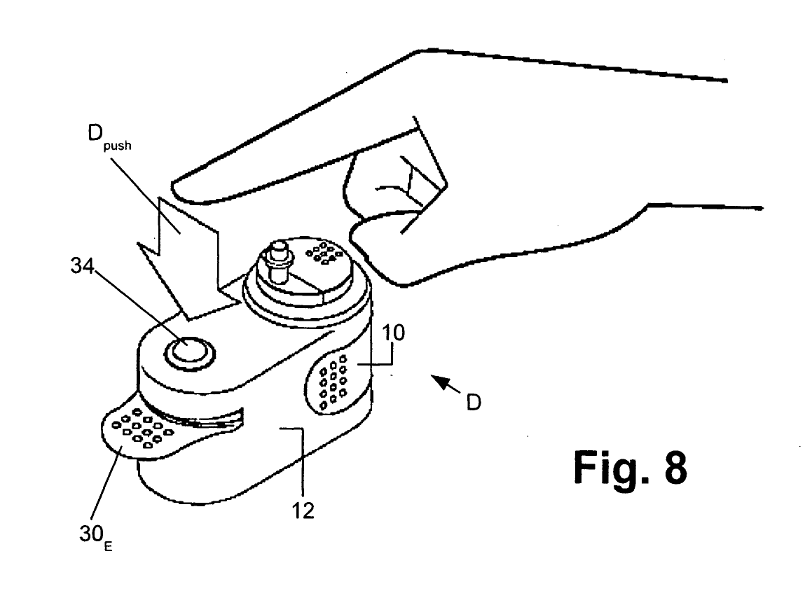

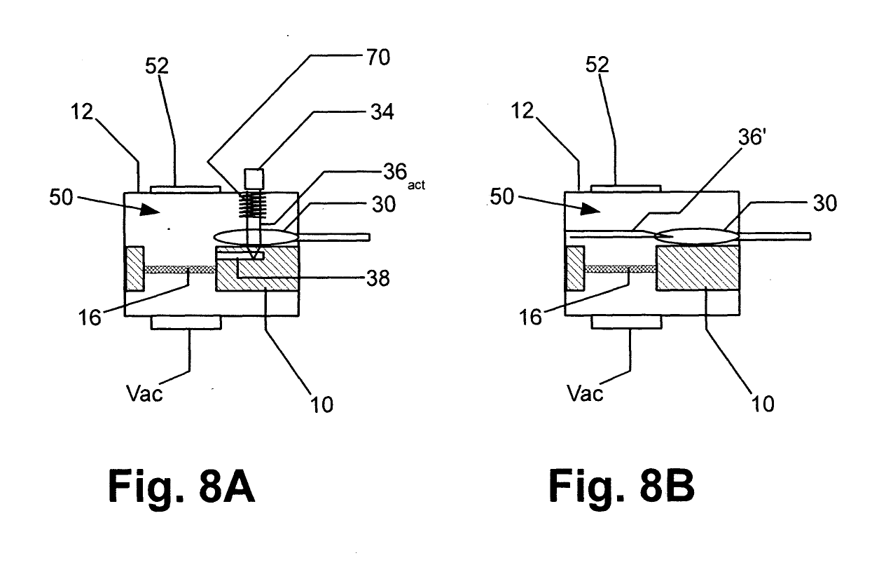

With reference to FIGS. 7, 8, 8A, and 8B, the sample staining operations C, D are described. FIG. 7 illustrates the operation C of inserting the staining fluid package 30 (in the illustrated embodiment, a stain blister pack 30) into the mating receptacle 32 of the sample container. An arrow Dᵢₙₛₑᵣₜ shown in FIG. 7 diagrammatically indicates the direction of insertion of the staining fluid package 30 into the mating receptacle 32. As seen in FIG. 8, the inserted blister pack 30 has a protruding end 30_{E} that protrudes out of the sample container to facilitate later removal of the blister pack 30 from the sample container. As further illustrated in FIG. 8 and with internal details shown in FIG. 8A, a user presses the push button 34 to push the stain release member 36 into and through the blister pack so as to rupture the blister pack. An arrow Dₚᵤₛₕ shown in FIG. 8 diagrammatically indicates the direction of pushing of the push button 34 to activate the stain release. FIG. 8A shows the activated release member position 36_{act} which has punched through the blister pack 30. A biasing spring 70 biases the push button 36 upward against the downward manual push—hence, when the user releases the activated push button 36_{act} the biasing spring 70 lifts the stain release member upward and out of the ruptured blister pack 30, so that the staining fluid can flow out of the blister pack 30 and into the stain fluid conduit 38 and thence to the sample substrate 16 in order to stain the sample. In some embodiments, the stain fluid conduit 38 is omitted and the staining fluid reaches the sample substrate by another method, such as in response to manual shaking of the sample container, or by substantially filling the sample container, or so forth. Although not illustrated, in some embodiments excess staining fluid is optionally removed by vacuuming via the vacuum port Vac, Vac′.

FIG. 8B illustrates an alternative embodiment, in which the push button is omitted and a differently configured stain release member 36′ is positioned to rupture the blister pack 30 at the point at which the blister pack is about fully inserted into the receptacle. In other words, in the variant embodiment of FIG. 8B the operation C of inserting the blister pack 30 into the sample container, as shown in FIG. 7, automatically causes the blister pack 30 to rupture and release the staining fluid at the point at which the blister pack 30 is about fully inserted into the receptacle 32. In such an embodiment, the separate operation D of activating the stain release is suitably omitted, as this is integrated into the insertion operation C.

FIGS. 7, 8, 8A, and 8B are illustrative examples, and other configurations are contemplated for the staining fluid package and/or the mating receptacle and/or the stain release mechanism.

With reference back to FIG. 4, the illustrated order of operations is that the particulate/fluid separation operation B is performed first, followed by the staining operations C, D. It is also contemplated to perform the staining first followed by particulate/fluid separation. In these latter embodiments, the fluid suitably provides the dispersion mechanism by which the staining fluid is dispersed over the sample substrate.

Moreover, in some embodiments the staining is omitted altogether, in which case operations C, D are both omitted. In such cases, the sample container can still include the mating receptacle 32 for receiving the blister pack (which is simply not used in these embodiments) or the receptacle 32 for the blister pack can be omitted.

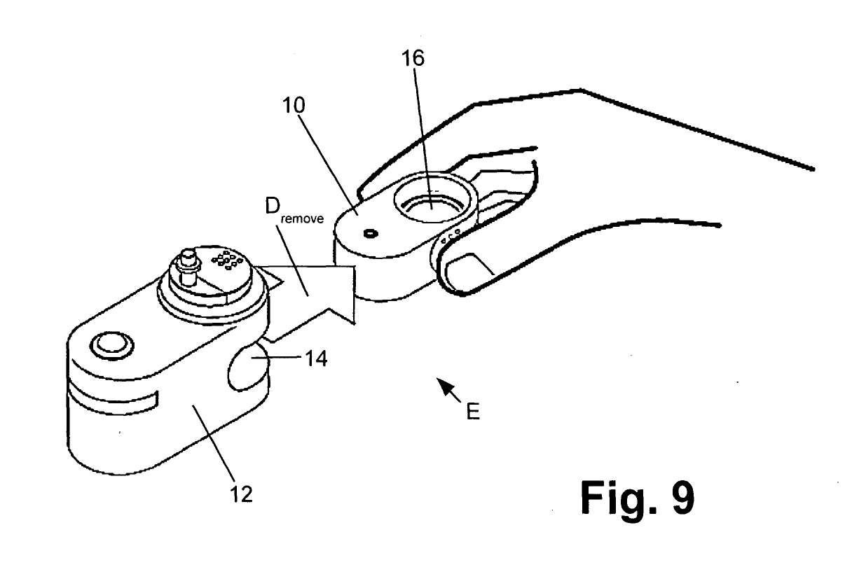

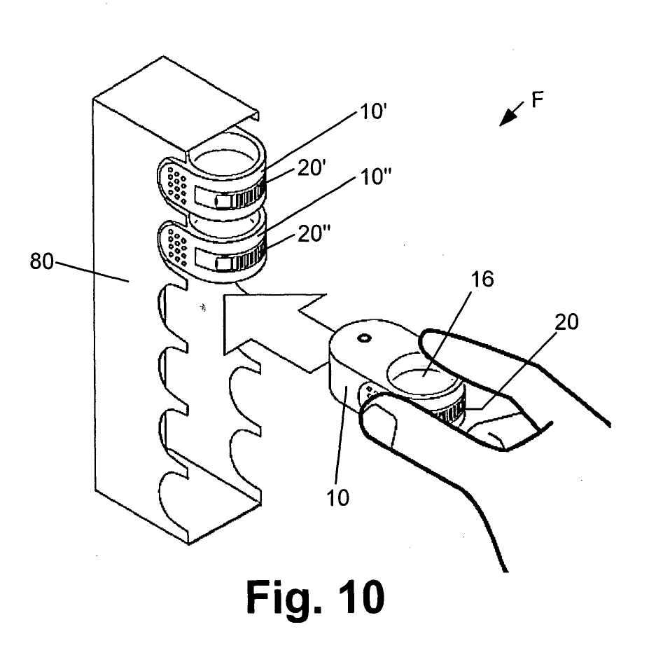

With reference to FIG. 9, the sample cartridge removal operation E is illustrated. In the illustrated embodiment, the sample cartridge 10 is retained in the enclosure 12 so as to form the sample container (as shown in FIG. 1, for example) by friction and/or by mechanical compression of the sample cartridge 10 in the mating slot 14 of the enclosure 12, and the separation entails the user pulling the sample cartridge and enclosure elements 10, 12 apart with sufficient force to overcome the frictional and/or compressive retention force(s). An arrow Dᵣₑₘₒᵥₑ shown in FIG. 9 diagrammatically indicates the direction of withdrawal of the sample cartridge 10 away from the enclosure 12. In other contemplated embodiments (not illustrated), a latch or other retention mechanism is employed, and the removal operation further entails releasing the latch or other retention mechanism. The identification element 20 (e.g., barcode label 20, see FIG. 1) is integral with the sample cartridge 10 and hence remains with the sample cartridge 10 when it is removed (best seen in FIG. 10). The sample substrate 16 is also integral with the sample cartridge 10 and hence remains with the sample cartridge 10 when it is removed.

In FIG. 9, the blister pack 30 is not in the enclosure, indicating that either it was not used or it was removed after the staining via the protruding end 30_{E} shown in FIG. 8. Alternatively, if the enclosure 12 is a disposable item that is not intended to be reused, then the blister pack 30 can be left in the enclosure 12 and the enclosure 12 with blister pack 30 still inserted disposed of as a unit.

With reference to FIG. 10, in the illustrated loading operation F the sample cartridge 10 is loaded into a multi-sample cartridge tray 80 that is in turn loaded (operation not shown) into the REBS testing apparatus. Implementation of the loading operation F depends on the nature of the testing apparatus, whether it employs a multi-sample loading element such as the illustrated cartridge tray 80, or a sample carousel, or so forth or whether the sample is loaded directly into the testing apparatus without an intermediate element, and other testing apparatus-specific aspects. Note that the multi-sample aspect of the illustrative cartridge tray 80 is diagrammatically shown in FIG. 10 by illustrating two sample cartridges 10′, 10″ with corresponding (and preferably unique) identification elements 20′, 20″ already loaded into the cartridge tray 80. In general, the sample cartridge 10 is advantageously shaped and sized for loading into the testing apparatus (or more specifically into a cartridge tray, e.g. the illustrative cartridge tray 80 or the like if such is used) so that the sample substrate 16 can be tested in situ within the sample cartridge 10. This eliminates the additional handling and consequent possibilities of contamination or human exposure that exist if the sample substrate 16 or the sample thereon or therein is transferred to another substrate for loading into the testing apparatus.

Once the loading operation F is completed, the sample testing is performed as per usual operational procedure of the testing apparatus.

With returning reference to FIG. 4, the distribution of the various operations A, B, C, D, E, F between the field worker and the laboratory worker can be various. In one approach, a large sample (for example, a large jar of liquid or a solid sample) is collected in the field and shipped to the laboratory for testing. In this case, all operations A, B, C, D, E, F including the collection operation A are suitably performed at the laboratory.

On the other hand, the collection operation A may be performed by a field worker in the field. The sample container disclosed herein is well suited for this approach, because the automation of collection and sample preparation processes within a single container substantially reduces the likelihood of sample contamination, worker exposure to a hazardous sample, or errors in the sample preparation operations. Advantageously, the field worker can have limited training. For example, the field worker can be sent to collect N samples, and for this purpose is provided with N sample containers configured as shown in FIG. 1 all with the correct cap type for the collection to be performed, and with N stain blister packs of the correct type each containing precisely the correct type and amount of stain fluid.

This last example assumes the field worker performs the particulate/fluid separation operation B and the staining operations C, D. In this case, the sample container after completion of operation D is delivered or transported to the laboratory, and the laboratory worker performs sample cartridge removal operation E and loading operation F. In this way, the sample remains protected in the assembled sample container during the delivery or transport.

In other embodiments, the sample container with the collected sample (that is, the output of the collection operation A) is sent to the laboratory, and the laboratory worker performs all remaining operations B, C, D, E, F. This approach may be suitable if it is expected that the particulates will remain in a more pristine state if kept immersed in the fluid during transport. When the sample arrives at the laboratory, the laboratory worker may optionally shake the sample container in compliance with a testing protocol in order to ensure that the particulates are in suspension within the fluid before performing the particulate/fluid separation operation B.

This application has described one or more preferred embodiments. Modifications and alterations may occur to others upon reading and understanding the preceding detailed description. It is intended that the application be construed as including all such modifications and alterations insofar as they come within the scope of the appended claims or the equivalents thereof.

1. An article of manufacture comprising:
a sample cartridge including a sample substrate; and
an enclosure including a sample ingress port, the enclosure mating with the sample cartridge to define a sample container containing the sample substrate which is accessible in the sample container via the sample ingress port, the sample cartridge including the sample substrate being removable from the sample container.

2. The article of manufacture as set forth in claim 1, further comprising:
a connection port disposed at the sample ingress port for inputting a fluid sample into the sample container.

3. The article of manufacture as set forth in claim 1, wherein the sample ingress port includes a resealable opening for inputting a sample into the sample container.

4. The article of manufacture as set forth in claim 3, wherein the resealable opening comprises a flip-top opening.

5. The article of manufacture as set forth in claim 1, further comprising:
a liquid disposed in the sample container; and
a cap removably disposed over the sample ingress port, the cap including a swab that is immersed in the liquid disposed in the sample container when the cap is disposed over the sample ingress port.

6. The article of manufacture as set forth in claim 1, wherein the enclosure further includes a vacuum port via which a fluid in the sample container is removable by vacuum while leaving particulates contained in the fluid on the sample substrate.

7. The article of manufacture as set forth in claim 6, wherein the sample substrate comprises a filter that retains particulates in the fluid while passing the fluid through the substrate responsive to a vacuum applied at the vacuum port.

8. The article of manufacture as set forth in claim 6, wherein the enclosure further includes an on-board reservoir for collecting fluid removed via the vacuum port.

9. The article of manufacture as set forth in claim 1, further comprising:
a staining fluid package containing a staining fluid, the staining fluid package configured for insertion into a mating opening of the enclosure, the enclosure configured to cause the staining fluid package inserted into the mating opening of the enclosure to release the staining fluid into the sample container.

10. The article of manufacture as set forth in claim 9, wherein the enclosure includes a stain release member configured to rupture the staining fluid package to release the staining fluid into the sample container.

11. The article of manufacture as set forth in claim 10, wherein the stain release member is configured to rupture the staining fluid package to release the staining fluid into the sample container responsive to insertion of the staining fluid package into the mating opening of the enclosure.

12. The article of manufacture as set forth in claim 10, wherein the stain release member is manually operable to cause the stain release member to rupture the staining fluid package.

13. The article of manufacture as set forth in claim 1, wherein the sample cartridge includes an identification element.

14. An article of manufacture comprising:
a sample substrate;
a sample container containing the sample substrate and including a sample ingress port providing access to the sample substrate in the sample container; and
a sample cartridge including the sample substrate, the sample cartridge including the sample substrate being removable as a unit from the sample container.

15. The article of manufacture as set forth in claim 14, further comprising:
a cap covering the sample ingress port and configured to admit a sample into the sample container through the covered sample ingress port.

16. The article of manufacture as set forth in claim 14, further comprising:
a plurality of caps adapted to cover the sample ingress port and to admit a sample into the sample container through the covered sample ingress port, the plurality of caps including at least two different caps selected from the group of caps consisting of:
a cap including a connection port for inputting a fluid sample into the sample container,
a cap including a resealable opening for inputting a sample into the sample container, and
a cap including a swab connected with the cap wherein the swab is disposed in the sample container when the cap covers the sample ingress port.

17. The article of manufacture as set forth in claim 14, wherein the sample container further includes a vacuum port via which a fluid in the sample container is removable by a vacuum applied at the vacuum port, the vacuum drawing fluid in the sample container through or across the sample substrate which retains particulates while passing the fluid.

18. The article of manufacture as set forth in claim 17, wherein the sample container further comprises:
an on-board reservoir for collecting fluid removed by vacuum applied at the vacuum port; and
a piston disposed in the reservoir and cooperating with the on-board reservoir to apply vacuum to the vacuum port.

19. The article of manufacture as set forth in claim 14, further comprising:
a staining fluid package containing a staining fluid, the staining fluid package configured for insertion into a receptacle of the sample container, the sample container configured to rupture the staining fluid package inserted into the receptacle of the sample container to release the staining fluid into the sample container.

20. An article of manufacture comprising:
a sample container including a removable sample cartridge having a sample substrate.

21. The article of manufacture as set forth in claim 20, wherein the sample container includes a vacuum port for vacuuming fluid out of the sample container while retaining particulates from the fluid at the sample substrate.

22. The article of manufacture as set forth in claim 21, wherein the sample container further includes a receptacle configured to receive and rupture a staining fluid package containing a staining fluid in order to apply the staining fluid to a sample in the sample container.

23. A sampling method comprising:
disposing a sample on a sample substrate in a sample container; and
removing a sample cartridge including the sample substrate from the sample container.

24. The sampling method as set forth in claim 23, further comprising:
after the disposing and prior to the removing, transporting the sample container with the sample disposed on the sample substrate from a sampling location to a testing location.

25. The sampling method as set forth in claim 24, further comprising:
after the removing, inserting the sample cartridge into a testing apparatus preparatory to testing the sample using the testing apparatus.

26. The sampling method as set forth in claim 23, wherein the disposing comprises one of (i) conveying a fluid containing a particulate sample into the sample container via a sample ingress port of the sample container and (ii) immersing a particulate sample into a fluid disposed in the sample container, and the sampling method further comprises:
after the disposing, withdrawing the fluid from the sample container through or across the sample substrate so as to retain the particulate sample on the sample substrate during the withdrawing.

27. The sampling method as set forth in claim 23, further comprising:
prior to the removing, staining the sample while the sample remains in the sample container disposed on the sample substrate, the staining comprising inserting a staining fluid package containing a staining fluid into a receptacle of the sample container and causing the inserted staining fluid package to rupture so as to release the staining fluid into the sample container.
